(19) United States
(12) Patent Application Publication
(10) Pub. No.: US 2023/0042848 A1
(43) Pub. Date: Feb. 9, 2023

(54) SECONDARY BATTERY

(71) Applicant: SANYO Electric Co., Ltd., Kadoma-shi, Osaka (JP)

(72) Inventors: Takafumi Hosokawa, Hyogo (JP); Taiki Nonaka, Hyogo (JP)

(73) Assignee: SANYO Electric Co., Ltd., Kadoma-shi, Osaka (JP)

(21) Appl. No.: 17/788,083

(22) PCT Filed: Dec. 15, 2020
(86) PCT No.: PCT/JP2020/046642

§ 371 Date: Jun. 22, 2022

(30) Foreign Application Priority Data
Dec. 27, 2019 (JP) 2019-237660

(51) Int. Cl. H01M 10/0583; H01M 50/451; H01M 50/46

(52) U.S. Cl. CPC H01M 10/0583; H01M 50/451; H01M 50/461

(57) ABSTRACT

This secondary battery is provided with an electrode body formed by laminating a positive electrode and a negative electrode with a separator interposed therebetween. The separator includes a first layer and a second layer having a lesser thermal shrinkage than the first layer, and has a tubular part that is formed in a tubular shape and that constitutes the outermost surface of the electrode body. The tubular part, of the separator, that constitutes the outermost surface of the electrode body has a tape stuck thereto in at least one end portion in the axial direction, the tape pressing the one end portion in the axial direction from one side to the other side in the lamination direction of the electrode body.

### TECHNICAL FIELD

The present invention generally relates to a secondary battery.

### BACKGROUND ART

In recent years, there has been an increasing demand for secondary batteries in various fields. In particular, for their ability to provide high energy density, lithium ion secondary batteries using non-aqueous electrolyte are widely used for in-vehicle application, power storage application, various electronic devices, and the like. The secondary battery comprises an electrode assembly including a positive electrode, a negative electrode, and a separator. The electrode assembly has a structure in which the separator is interposed between the positive electrode and the negative electrode, thereby preventing contact between the positive electrode and the negative electrode. There are proposed numerous means for more surely preventing the occurrence of internal short circuit caused by contact between the positive electrode and the negative electrode.

For example, in PATENT LITERATURE 1, there is proposed a method in which an adhesive layer is provided on a surface of a separator and an electrode assembly is thermocompression bonded to bond the surface of the separator and a surface of an electrode, to prevent internal short circuit from occurring due to a stacking position shift between the positive electrode and the negative electrode. In PATENT LITERATURE 2, there is proposed a secondary battery comprising a separator in which a heat-resistant porous layer containing inorganic particles is formed on a surface of a substrate, to prevent internal short circuit from occurring due to a conductive foreign substance.

### CITATION LIST

### Patent Literature

PATENT LITERATURE 1: Japanese Unexamined Patent Application Publication No. 2018-56142
PATENT LITERATURE 2: Japanese Unexamined Patent Application Publication No. 2018-49758

### SUMMARY

In the outermost surfaces of the electrode assembly in which no facing electrodes exist, the electrodes are also covered by the separator to prevent the mixture layers of the electrodes from being exposed, but the end of the separator may be turned up, causing exposure of a part of the mixture layer. Once the electrode mixture layer in the outermost surface of the electrode assembly is exposed, the exposed portion may fall off to enter the electrode assembly, piercing the separator, which may cause micro-short circuit. In particular, when the electrode assembly is manufactured through the thermocompression bonding step using the separator including two or more layers having different thermal shrinkage rates, rising or turning up of the end of the separator is increased.

A secondary battery according to the present disclosure is a secondary battery comprising an electrode assembly in which a positive electrode and a negative electrode are stacked with a separator interposed therebetween, wherein the separator includes a first layer and a second layer having a thermal shrinkage rate smaller than that of the first layer, and has a tubular portion that is formed into a tubular shape to form outermost surfaces of the electrode assembly, and in the tubular portion of the separator, a tape is attached to at least one end in an axial direction of the tubular portion, the tape extending across the electrode assembly in a stacking direction of the electrode assembly and fastening the at least one end in the axial direction together.

The secondary battery according to the present disclosure makes it possible to prevent the mixture layer of the electrode from being exposed to the outermost surface of the electrode assembly due to turning up of the end of the separator. This can prevent internal short circuit from occurring due to fall-off of the electrode mixture layer.

### BRIEF DESCRIPTION OF DRAWING

FIG. 1 is a perspective view illustrating an appearance of a secondary battery, which is an example of embodiments.

FIG. 2 is a perspective view of an electrode assembly, which is an example of embodiments.

FIG. 3 is a perspective view of an electrode assembly, which is another example of embodiments.

### DESCRIPTION OF EMBODIMENTS

Hereinafter, an example of an embodiment of the present disclosure will be described with reference to the drawings. Note that it has been assumed from the outset that a plurality of embodiments and variants which are exemplified below can be selectively combined.

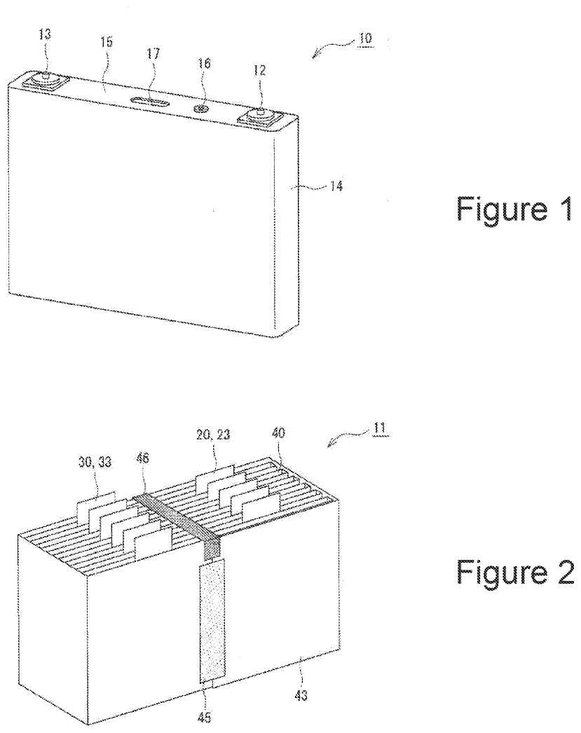

FIG. 1 is a perspective view illustrating an appearance of a secondary battery 10, which is an example of embodiments, and FIG. 2 is a perspective view of an electrode assembly 11 forming the secondary battery 10. The secondary battery 10 exemplified below is a so-called rectangular battery in which the electrode assembly 11 is housed in a rectangular exterior can 14, but an exterior body of the battery is not limited to the exterior can 14, and, for example, may be an exterior body formed of a laminate sheet including a metal layer and a resin layer. Also, in the following description, a stacked electrode assembly 11 is exemplified which is formed in a structure in which a plurality of positive electrodes and a plurality of negative electrodes are stacked with a separator interposed therebetween, but the electrode assembly may be a wound electrode assembly.

As illustrated in FIGS. 1 and 2, the secondary battery 10 comprises the electrode assembly 11 formed by stacking positive electrodes 20 and negative electrodes 30 with a separator 40 interposed therebetween, the bottomed rectangular tubular exterior can 14 configured to house the electrode assembly 11, and a sealing plate 15 configured to close an opening of the exterior can 14. The exterior can 14 is a flat, substantially rectangular parallelepiped metal container, which is open on one side in an axial direction, and the sealing plate 15 has an elongated rectangular shape. Each of the exterior can 14 and the sealing plate 15 is made of a metal material containing aluminum as a main component, for example.

In the following description, the height direction of the exterior can 14 is referred to as an “up and down direction” of the secondary battery 10 and each component, the sealing plate 15 side is referred to as “upper,” and the bottom portion side of the exterior can 14 is referred to as “lower,” for convenience of description. The direction along a longitudinal direction of the sealing plate 15 is referred to as a “lateral direction” of the secondary battery 10 and each component. In the electrode assembly 11, a portion except for a tubular portion 43 of the separator 40, which will be described later, may be referred to as an “electrode group”.

The secondary battery 10 comprises the electrode assembly 11 and an electrolyte housed in the exterior can 14. The electrolyte may be an aqueous electrolyte, and preferably be a non-aqueous electrolyte. The non-aqueous electrolyte contains a non-aqueous solvent, and an electrolyte salt dissolved in the non-aqueous solvent, for example. As the non-aqueous solvent, for example, esters, ethers, nitriles, amides, or a mixed solvent containing at least two of those mentioned above may be used. The non-aqueous solvent may also contain a halogen substitute in which at least one hydrogen atom of each of those solvents mentioned above is substituted by a halogen atom such as fluorine. As the electrolyte salt, for example, a lithium salt such as LiPF₆ is used.

The electrode assembly 11 includes a plurality of positive electrodes 20 and a plurality of negative electrodes 30, and has a structure in which the positive electrodes 20 and the negative electrodes 30 are alternately stacked one by one via the separator 40. In general, in the electrode assembly 11, the number of negative electrodes 30 is greater than the number of positive electrodes 20 by one, so that the negative electrodes 30 are provided at both ends in the stacking direction of the electrode group. The separator 40 has the tubular portion 43 which is formed into a tubular shape to form outermost surfaces of the electrode assembly 11. That is, on the outermost surfaces of the electrode assembly 11, the separator 40 is tubularly wound one or more turns, and the negative electrodes 30 provided at both sides in the stacking direction of the electrode group are covered by the separator 40.

The electrode assembly 11 has a stacking structure in which one sheet of separator 40 folded in a zigzag shape is interposed between the positive electrodes 20 and the negative electrodes 30. Then, the tubular portion 43 is formed by such one sheet of separator 40. Note that the separator interposed between the positive electrodes and the negative electrodes may be separated from the separator forming the outermost surfaces of the electrode assembly, and therefore, the electrode assembly may include a plurality of separators, each of which is provided between the positive electrode and the negative electrode, and one sheet of separator forming a tubular portion.

The electrode assembly 11 has a plurality of positive electrode tabs 23 and a plurality of negative electrode tabs 33, the tabs extending toward the sealing plate 15 side. For example, the positive electrode tab 23 is a part of a core of the positive electrode 20 which is formed to project upward, and similarly, the negative electrode tab 33 is a part of a core of the negative electrode 30 which is formed to project upward. The positive electrodes 20 and the negative electrodes 30 are stacked with the separator 40 interposed therebetween so that the positive electrode tabs 23 and the negative electrode tabs 33 are oriented toward the same direction, the positive electrode tabs 23 are located on one end side in the lateral direction of the electrode assembly 11 and the negative electrode tabs 33 are located on the other end side in the lateral direction of the electrode assembly 11.

A positive electrode terminal 12 and a negative electrode terminal 13 are attached to the sealing plate 15. For example, the positive electrode tabs 23 are electrically connected to the positive electrode terminal 12 via a positive electrode current collector (not illustrated), and the negative electrode tabs 33 are electrically connected to the negative electrode terminal 13 via a negative electrode current collector (not illustrated). The positive electrode terminal 12 and the negative electrode terminal 13 are external connection terminals to be electrically connected to another secondary battery 10, electronic device, or the like, and are attached to the sealing plate 15 via an insulating member. The sealing plate 15 is generally provided with a liquid injection portion 16 for injecting the electrolytic solution, and a gas discharge vent 17 for opening a vent in the event of a battery malfunction to discharge gas.

Hereinafter, the positive electrode 20, the negative electrode 30, and the separator 40 forming the electrode assembly 11 will be described in detail, with particular reference to the layer structure and arrangement of the separator 40.

[Positive Electrode]

The positive electrode 20 has a positive electrode core and a positive electrode mixture layer formed on a surface of the positive electrode core. Examples of the positive electrode core include a foil of a metal that is stable in a potential range of the positive electrode 20, such as aluminum or an aluminum alloy, and a film in which such a metal is provided on the surface layer. The positive electrode mixture layer contains a positive electrode active material, a conductive agent, and a binder, and is preferably provided on each side of the positive electrode core. The positive electrode 20 can be fabricated by, for example, applying a positive electrode mixture slurry containing a positive electrode active material, a conductive agent, a binder, and the like on the positive electrode core, drying the resulting coating film, and then compressing it to form a positive electrode mixture layer on each side of the positive electrode core.

A lithium transition metal composite oxide is used as the positive electrode active material. Examples of a metal element contained in the lithium transition metal composite oxide include Ni, Co, Mn, Al, B, Mg, Ti, V, Cr, Fe, Cu, Zn, Ga, Sr, Zr, Nb, In, Sn, Ta, and W. In particular, at least one of Ni, Co, and Mn is preferably contained. Suitable examples of the composite oxide include a lithium transition metal composite oxide containing Ni, Co, and Mn, and a lithium transition metal composite oxide containing Ni, Co, and Al.

Examples of the conductive agent contained in the positive electrode mixture layer can include carbon materials such as carbon black, acetylene black, Ketjenblack, and graphite. Examples of the binder contained in the positive electrode mixture layer can include fluororesin such as polytetrafluoroethylene (PTFE) and polyvinylidene fluoride (PVdF), polyacrylonitrile (PAN), polyimide resins, acrylic resins, and polyolefin resins. Also, these resins may be used in combination with a cellulose derivative such as carboxymethyl cellulose (CMC) or a salt thereof, a polyethylene oxide (PEO), or the like.

[Negative Electrode]

The negative electrode 30 has a negative electrode core and a negative electrode mixture layer formed on a surface of the negative electrode core. Examples of the negative electrode core include a foil of a metal that is stable in a potential range of the negative electrode 30, such as copper, and a film in which such a metal is provided on the surface layer. The negative electrode mixture layer contains a negative electrode active material and a binder, and is preferably formed on each side of the negative electrode core. The negative electrode 30 can be fabricated by, for example, applying a negative electrode mixture slurry containing a negative electrode active material, a binder, and the like on each surface of the negative electrode core, drying the resulting coating film, and then compressing it to form a negative electrode mixture layer on each side of the negative electrode core.

The negative electrode mixture layer contains, for example, a carbon-based active material that reversibly occludes and releases lithium ions as the negative electrode active material. A preferable carbon-based active material is graphite including natural graphite such as flake graphite, massive graphite, and earthy graphite, and artificial graphite such as massive artificial graphite (MAG) and graphitized mesophase carbon microbeads (MCMB). As the negative electrode active material, an Si-based active material that is comprised of at least one of Si and an Si-containing compound may be used, and a carbon-based active material and an Si-based active material may be used in combination.

As the binder contained in the negative electrode mixture layer, a fluororesin, PAN, a polyimide, an acrylic resin, and a polyolefin, or the like may be used in the same manner as in the case of the positive electrode 20, and a styrene-butadiene rubber (SBR) is preferably used. Preferably, the negative electrode mixture layer may further contain CMC or a salt thereof, polyacrylic acid (PAA) or a salt thereof, polyvinyl alcohol (PVA), or the like. In particular, SBR may be preferably used in combination with CMC or a salt thereof, or PAA or a salt thereof

[Separator]

A porous sheet having ion permeability and insulating properties is used as the separator 40. The separator 40 includes at least two layers having different thermal shrinkage rates, and specifically includes a first layer and a second layer having a thermal shrinkage rate smaller than that of the first layer. For example, the separator 40 includes a porous resin substrate which is a resin layer serving as the first layer, and a porous heat resistant layer containing inorganic particles which serves as the second layer. The heat resistant layer is formed on one side of the resin substrate. Providing the heat resistant layer makes it difficult to cause breakage of the separator 40 due to a conductive foreign substance, and can reduce shrinkage of the separator 40 when the temperature increases. The heat resistant layer is preferably formed only on one side of the resin substrate to increase the cost effectiveness while reducing an increase in thickness of the electrode assembly 11. Note that the thermal shrinkage rate refers to the degree of shrinkage (length change) when the separator 40 is heated. The thermal shrinkage rate of the second layer is smaller than the heat thermal shrinkage rate of the first layer, for example, at 110° C. (a heating temperature while applying a load to the electrode assembly, which will be described later).

Note that the separator 40 may have a third layer. The separator 40 may include a resin layer having high heat resistance that is made of a resin (such as an aramid resin, a polyimide, or a polyamide-imide, for example) having a higher melting point or softening point than that of a resin forming the resin substrate, instead of the heat resistant layer or in addition to the heat resistant layer.

The resin substrate independently serves as a separator. A porous film having ion permeability and insulating properties is used as the resin substrate. A thickness of the resin substrate is, for example, 1 μm to 20 μm, and preferably 5 μm to 15 μm. Examples of a material for the resin substrate include polyethylene, polypropylene, an ethylene-propylene copolymer, and an olefin resin such as a copolymer with ethylene, propylene, or another α-olefin. A melting point of the resin substrate is generally 200° C. or lower.

The heat resistant layer contains inorganic particles as main components. The heat resistant layer preferably contains insulating inorganic particles, and a binder binding the particles to each other and binding the particles to the resin substrate. The heat resistant layer has ion permeability and insulating properties as with the resin substrate. A thickness of the heat resistant layer is, for example, 1 μm to 10 μm, and preferably 1 μm to 6 μm.

At least one selected from alumina, boehmite, silica, titania, and zirconia can be used as the inorganic particles, for example. In particular, alumina or boehmite is preferably used. The contained amount of the inorganic particles is preferably 85% by mass to 99.9% by mass and more preferably 90% by mass to 99.5% by mass with respect to the mass of the heat resistant layer.

The same resins as the binders contained in the positive electrode mixture layer and the negative electrode mixture layer, such as fluorocarbon resins including PVdF, and SBR can be used as the binder contained in the heat resistant layer.

The contained amount of the binder is preferably 0.1% by mass to 15% by mass and more preferably 0.5% by mass to 10% by mass with respect to the mass of the heat resistant layer. The heat resistant layer is formed by, for example, applying slurry containing inorganic particles and a binder to one side of the resin substrate, and drying the resulting coating film.

For example, an adhesive layer to be bonded to a surface of the positive electrode 20 or the negative electrode 30 is formed on at least one surface of the separator 40. The adhesive layer may be formed on each side of the separator 40, and in this case, the structure of the adhesive layer may be different between one side and the other side. A thickness of the adhesive layer is, for example, 0.1 μm to 1 μm or 0.2 μm to 0.9 μm. The adhesive layer is formed by, for example, applying an emulsion adhesive in which the adhesive component is dispersed in water to the surface of the separator 40, and drying the resulting coating film. The adhesive layer may be formed in a dotted shape, for example.

The adhesive layer has no adhesive property at room temperature (25° C.), and preferably exhibits an adhesive property by heating. An example of the adhesive forming the adhesive layer is an adhesive made from an acrylic resin as a main component. The electrode assembly 11 is manufactured by, for example, stacking the negative electrode 30, the separator 40 with adhesive layers, the positive electrode 20, and the separator 40 with adhesive layers in this order, and subjecting the resulting laminate to a hot pressing step (thermocompression bonding step). Note that in the hot pressing step, the resin substrate is heated, which may cause thermal shrinkage.

The separator 40 is preferably provided so that the heat resistant layer faces the positive electrode 20 side. That is, the separator 40 is provided between the positive electrode 20 and the negative electrode 30 in the state in which the resin substrate contacts the negative electrode 30 and the heat resistant layer contacts the positive electrode 20. In this case, the oxidation deterioration of the resin substrate of the separator 40 due to the positive electrode potential can be further reduced as compared with a configuration in which the resin substrate faces the positive electrode 20 side. In the present embodiment, the heat resistant layer is provided on each side of all of the positive electrodes 20.

The separator 40 is folded in a zigzag shape and is interposed between the positive electrodes 20 and the negative electrodes 30, and is formed into a tubular shape to form outermost surfaces of the electrode assembly 11. The tubular portion 43 of the separator 40 forming the outermost surfaces of the electrode assembly 11 is formed by tubularly winding the separator 40 one or more turns along the side surfaces of the electrode group, and covers the entire side surfaces of the electrode group to prevent the side surfaces from being exposed to the outside. Here, the side surfaces of the electrode group refer to surfaces along the up and down direction of the electrode assembly 11, the surfaces including both end surfaces in the stacking direction of the electrode group (in the present embodiment, surfaces of the negative electrodes 30 provided at both ends in the stacking direction of the electrode group, which do not face the positive electrodes 20) and surfaces along the stacking direction of the electrode group.

The separator 40 is attached to cover the entirety of the mixture layers of the negative electrodes 30 located most outside in the stacking direction. That is, the tubular portion 43 is formed by tubularly winding the separator 40 around the side surfaces of the electrode group to prevent the mixture layers of the negative electrodes 30 from being exposed to the outermost surfaces of the electrode assembly 11. In the present embodiment, the separator 40 is wound two turns around a part of the side surfaces of the electrode group to thereby form two layers of the separator 40. That is, a part of the tubular portion 43 is formed by the two layers of the separator 40, and a remaining part is formed by one layer of the separator 40.

A tape 45 is attached to a winding finish end of the separator 40 located on the outermost surface of the electrode assembly 11, to maintain the shape of the tubular portion 43. For example, the tape 45 is attached to bridge between the winding finish end of the second layer separator 40 located outside of the tubular portion 43 and the first layer separator 40 wound inside thereof. The tubular portion 43 may be formed by winding the separator 40 three or more turns around the side surfaces of the electrode group, to be formed of three or more layers of separator 40, and the tubular portion 43 is preferably formed of one layer or two layers of separator 40. An increase in the number of layers of the separator 40 forming the tubular portion 43 makes it easier to prevent rising or turning up of the end of the separator 40, but for example, excess separator 40 absorbs the electrolytic solution, which causes the deterioration of the charge-discharge cycle characteristics.

On one end in at least axial direction (in the present embodiment, one end in a width direction of the separator 40) in the tubular portion 43 of the separator 40, a tape 46 is attached to a range from one side to the other side in the stacking direction of the electrode assembly 11 to fasten the one end in the axial direction together. Fastening the end in the axial direction of the tubular portion 43 using the tape 46 makes it possible to prevent the mixture layer of the negative electrode 30 from being exposed to the outermost surface of the electrode assembly 11 due to turning up of the end of the separator 40. This can prevent internal short circuit from occurring due to fall-off of the mixture layer.

In the example illustrated in FIG. 2, the tape 46 is attached to an upper end which is one end in the axial direction of the tubular portion 43, whereas the tape 46 is not attached to a lower end which is the other end in the axial direction. A width of the separator 40 is generally larger than the width of the negative electrode 30 (the width of a portion in which the negative electrode tab 33 is not formed), and in the tubular portion 43, the upper end with respect to the separator 40 has larger margin than the lower end with respect to the separator 40. This makes it easier to cause rising or turning up of the separator 40 at the upper end of the tubular portion 43, and therefore the tape 46 is preferably attached to at least the upper end.

The tape 46 is attached to the outermost surface on one side in the stacking direction of the electrode assembly 11 (hereinafter, referred to as a “front surface of the electrode assembly 11”) in the upper end of the tubular portion 43, extends across the the electrode assembly 11 in a stacking direction, and is attached to the outermost surface on the other side in the stacking direction of the electrode assembly 11 (hereinafter, referred to as a “rear surface of the electrode assembly 11”). In the example illustrated in FIG. 2, in the front surface of the electrode assembly 11, the tape 46 is attached to bridge between the first layer and the second layer of the separator 40 in the same manner as in the case of the tape 45. Note that the tape 46 may extend to the lower portion of the electrode assembly 11 along the winding finish end of the separator 40 to be also used as the tape 45.

The tape 46 is attached in a tightened manner without being loosened, from the upper end of the front surface to the upper end of the rear surface of the electrode assembly 11. In this case, the upper end of the tubular portion 43 is pulled inward, which makes it difficult to cause rising or turning up. The tape 46 covers a part of the upper surface of the electrode assembly 11 and extends in the stacking direction of the electrode assembly 11. For example, the tape 46 passes between the positive electrode tab 23 and the negative electrode tab 33, and is equally spaced apart from the positive electrode tab 23 and the negative electrode tab 33. Note that the tape 46 is preferably attached so as to avoid a position directly below the liquid injection portion 16 not to overlap with the liquid injection portion 16 in the up and down direction.

The tape 46 may be formed wide within a range of not interfering with the positive electrode tabs 23 and the negative electrode tabs 33 and not overlapping with the liquid injection portion 16 in the up and down direction. In the example illustrated in FIG. 2, the width of the tape 46 is smaller than the width of the tape 45, but the tape 46 may be wider than the tape 45. An example of the width of one sheet of tape 46 is 10 mm to 20 mm, and corresponds to 5% to 30% of the length in the lateral direction of the electrode assembly 11. A length along the up and down direction of the tape 46 attached to each of the front surface and the rear surface of the electrode assembly 11 is, for example, 5 mm to 15 mm, and corresponds to 5% or more of the length in the up and down direction of the electrode assembly 11.

In the present embodiment, each of the positive electrode 20 and the negative electrode 30 has a substantially rectangular shape in front view. The tape 46 is attached at a position overlapping with a center in a long side direction of each of the positive electrode 20 and the negative electrode 30. Since in the separator 40, the biggest rising or turning up occurs easily at the center in the long side direction in each of the front surface and the rear surface of the electrode assembly 11, such a form of applying a tape 46 is effective in preventing rising or turning up of the separator 40.

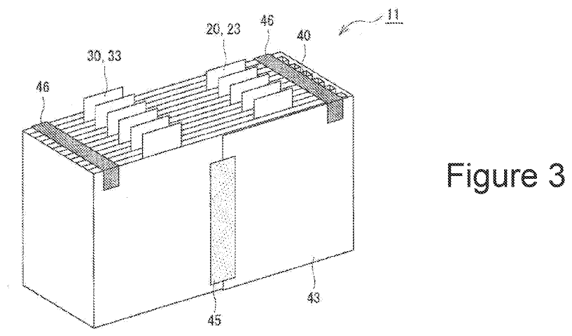

As illustrated in FIG. 3, in at least one end in the axial direction of the tubular portion 43, one sheet of tape 46 may be attached to each side in the lateral direction of the electrode assembly 11. In the example illustrated in FIG. 3, in a portion between one end in the lateral direction of the electrode assembly 11 and the positive electrode tabs 23, the tape 46 is attached closer to one end in the lateral direction. In addition, in a portion between the other end in the lateral direction of the electrode assembly 11 and the negative electrode tabs 33, the tape 46 is attached closer to the other end in the lateral direction.

Note that in the example illustrated in FIG. 3, the tape 46 is not attached between the positive electrode tabs 23 and the negative electrode tabs 33, but on the tubular portion 43, the tape 46 may be attached to a center in the lateral direction, in addition to two sheets of tape 46 attached to both sides in the lateral direction of the electrode assembly 11. The number of sheets of tape 46 is not limited to a particular value, and four or more sheets of tape may be attached, but the number of sheets of tape 46 is preferably three or more from the viewpoint of productivity. In addition, the tape 46 may be attached to each of upper and lower ends of the tubular portion 43, and the form of applying the tape 46 may be different between the upper end and the lower end of the tubular portion 43.

The tapes 45 and 46 each are an adhesive tape including, for example, an insulating resin substrate and an adhesive layer. The same tape can be used for the tapes 45 and 46. A thickness of the tape 45, 46 is, for example, 10 μm to 60 μm, and preferably 15 μm to 40 μm. The resin substrate has the durability against the electrolyte, and is formed of, for example, a resin including polyester such as polyethylene terephthalate, polypropylene, polyimide, polyphenylene sulfide, polyetherimide, polyamide, or the like.

It is assumed that the separator 40 thermally shrinks in the above-described hot pressing step in the same manner as in the case of the conventional separator. In the conventional separator, rising or turning up easily occurs at the end in the axial direction of the tubular portion due to thermal shrinkage, but according to the separator 40, the tape 46 can be used to prevent such rising or turning up, and highly prevent the mixture layer of the negative electrode 30 from being exposed to the outermost surface of the electrode assembly 11. Note that the separator 40 may thermally shrink due to heat generation not only in the hot pressing step but also in using the secondary battery 10.

The separator 40 is preferably provided so that in the tubular portion 43, the first layer having a large thermal shrinkage rate faces the inner side of the electrode assembly 11, and the second layer having a thermal shrinkage rate smaller than that of the first layer faces the outer side of the electrode assembly 11. In the present embodiment, the separator 40 is provided so that the resin substrate faces the inner side, and the heat resistant layer faces the outer side. In this case, the heat resistant layer functions as a rigid layer that maintains the shape of the separator 40, which prevents the end in the axial direction of the tubular portion 43 from being warped outward to cause turning up. Such arrangement can further prevent rising or turning up of the end in the axial direction of the tubular portion 43.

### EXAMPLES

Hereinafter, although the present disclosure will be further described in detail with reference to Examples, the present disclosure is not limited to the following Examples.

### Example 1

[Fabrication of Positive Electrode]

As a positive electrode active material, a lithium nickel cobalt manganese composite oxide was used. The positive electrode active material, acetylene black, and polyvinylidene fluoride (PVdF) were mixed together at a solid component mass ratio of 97:2:1, so that a positive electrode mixture slurry was prepared using N-methyl-2-pyrrolidone (NMP) as a dispersion medium. Next, the positive electrode mixture slurry was applied onto both surfaces of the positive electrode core formed of an aluminum foil with a thickness of 13 μm except for a portion serving as the positive electrode tab, and the resulting coating films were dried and compressed, followed by cutting to a predetermined electrode size, thereby obtaining a positive electrode (76 mm×139 mm) having a positive electrode mixture layer (thickness: 62 μm for one side) formed on each of both surfaces of the positive electrode core. In addition, the positive electrode tab is formed in the positive electrode, the positive electrode tab having a width of 20 mm and being a part of the core formed to project upward.

[Fabrication of Negative Electrode]

As a negative electrode active material, graphite was used. The negative electrode active material, carboxymethyl cellulose (CMC), and a styrene-butadiene rubber (SBR) were mixed together at a solid component mass ratio of 98:1:1, so that a negative electrode mixture slurry was prepared using water as a dispersion medium. Next, the negative electrode mixture slurry was applied onto both surfaces of the negative electrode core formed of a copper foil with a thickness of 8 μm except for a portion serving as the negative electrode tab, and the resulting coating films were dried and compressed, followed by cutting to a predetermined electrode size, thereby obtaining a negative electrode (78 mm×143 mm) having a negative electrode mixture layer (thickness: 76 μm for one side) formed on each of both surfaces of the negative electrode core. In addition, the negative electrode tab is formed in the negative electrode, the negative electrode tab having a width of 18 mm and being a part of the core formed to project upward.

[Fabrication of Separator]

As a resin substrate, a porous substrate having a thickness of 12 μm and made of polyethylene was used, and a slurry containing alumina particles and PVdF was applied to one side of the substrate to form a heat resistant layer having a thickness of 4 μm, thereby obtaining a separator (width: 81 mm) having a two-layer structure including the porous resin substrate and the porous heat resistant layer. The adhesive containing an acrylic resin as a main component was applied in a dot shape on each of both sides of the separator, to form an adhesive layer.

[Preparation of Non-Aqueous Electrolytic Solution]

Ethylene carbonate (EC) and methyl ethyl carbonate (EMC), and dimethyl carbonate (DMC) were mixed together in a volume ratio (25° C., 1 atm) of 3:3:4. To the mixed solvent, LiPF₆ was dissolved with a concentration of 1 mol/L, and a non-aqueous electrolytic solution was thus prepared.

[Fabrication of Electrode Assembly]

An electrode group was fabricated by alternately stacking the 35 positive electrodes and the 36 negative electrodes one by one via the separator folded in a zigzag shape, and the separator was wound around the side surfaces of the electrode group and the winding finish end of the separator was fixed by the adhesive tape, thereby obtaining a laminate (electrode assembly before thermocompression bonding) in which the entire side surfaces of the electrode group are covered by the separator. Note that the separator is provided so that the heat resistant layer faces the positive electrode side in a portion between the positive electrode and the negative electrode. The adhesive tape having a width of 15 mm for fastening the upper end of the tubular portion together was attached to the tubular portion of the separator covering the side surfaces of the electrode group without being loosened from the front surface to the rear surface of the laminate. As illustrated in FIG. 2, the tape was attached to overlap with a center in the long side direction of each of the positive electrode and the negative electrode (a center in the lateral direction of the laminate), and a length in the up and down direction of the tape to attached to the front surface and the rear surface of the laminate was set to 10 mm.

The laminate was heated using a hot plate of 110° C. for 43 seconds while applying a load of 20 kN to the laminate, thereby obtaining an electrode assembly.

[Fabrication of Secondary Battery]

A plurality of positive electrode tabs extending from the electrode assembly were connected to a positive electrode terminal via a current collector, and similarly, a plurality of negative electrode tabs were connected to a negative electrode terminal via a current collector. The positive electrode terminal and the negative electrode terminal were fixed to the sealing plate via respective insulating members. The electrode assembly was housed in the bottomed rectangular tubular exterior can, and then the sealing plate was connected to an opening edge of the exterior can by laser welding. The non-aqueous electrolytic solution was injected from an injection vent of the sealing plate, and the injection vent was sealed by blind rivets, thereby obtaining a non-aqueous electrolyte secondary battery having external dimensions of 148 mm wide×91 mm high×26.5 mm thick.

### Example 2

An electrode assembly and a secondary battery were obtained in the same manner as in Example 1, except that as illustrated in FIG. 3, one sheet of tape was attached to each side in the lateral direction of the electrode assembly, the tape pressing the upper end of the separator from the front surface to the rear surface of the electrode assembly.

### Comparative Example 1

An electrode assembly and a secondary battery were obtained in the same manner as in Comparative Example 1, except that no tape was used, the tape being attached from the front surface to the rear surface of the electrode assembly.

The electrode assemblies of Examples and Comparative Example were tested by the methods described below to evaluate rising or turning up of 90° or more of the separator and exposure of the negative electrode mixture layer in the outermost surface of the electrode assembly. The evaluation results are shown in Table 1.

[Evaluation of Rising or Turning up of 90° or More of Separator and Exposure of Negative Electrode Mixture Layer]

Each electrode assembly of Examples and Comparative Example was placed on a desk to direct a plane located at one end in the longitudinal direction of the separator downward, there was observed the end in the axial direction of the tubular portion of the separator forming the outermost surfaces of the electrode assembly, to determine whether rising or turning up of 90° or more (outward warp) of the separator occurred and whether the negative electrode mixture layer was exposed to the outermost surface of the electrode assembly.

TABLE 1

| | | Turning | Exposure of |
|---|---|---|---|
| | | Up of 90° | Negative Electrode |
| | Rising | or More | Mixture Layer |
| Example 1 | No | No | No |
| Example 2 | Yes | Yes | No |
| Comparative | Yes | Yes | Yes |
| Example 1 | | | |

As shown in Table 1, in the electrode assembly of Example 1, it was found that neither rising nor turning up occurred at the upper end of the separator, and therefore the negative electrode mixture layer was not exposed to the outermost surface of the electrode assembly. In the electrode assembly of Example 2, it was found that rising and turning up occurred at the center in the lateral direction separated from the tape, but since the degrees were small, the exposure of the negative electrode mixture layer was not caused, and therefore the effect of preventing exposure of the negative electrode mixture layer was obtained in the same manner as in the case of Example 1. On the other hand, in the electrode assembly of Comparative Example 1, rising and turning up of 90° or more occurred at the upper end of the separator, and therefore the negative electrode mixture layer was exposed to the outermost surface of the electrode assembly.

### REFERENCE SIGNS LIST

10 Secondary battery
11 Electrode assembly
12 Positive electrode terminal
13 Negative electrode terminal
14 Exterior can
15 Sealing plate
16 Liquid injection portion
17 Gas discharge vent
20 Positive electrode
23 Positive electrode tab
30 Negative electrode
33 Negative electrode tab
40 Separator
43 Tubular portion
45, 46 Tape

1. A secondary battery, comprising:
an electrode assembly in which a positive electrode and negative electrode are stacked with a separator interposed between the positive electrode and the negative electrode,
wherein the separator includes a first layer and a second layer having a thermal shrinkage rate smaller than a thermal shrinkage rate of the first layer, and has a tubular portion that is formed into a tubular shape to form outermost surfaces of the electrode assembly, and
in the tubular portion of the separator, a tape is attached to at least one end in an axial direction of the tubular portion, the tape extending across the electrode assembly in a stacking direction of the electrode assembly and fastening the at least one end in the axial direction together.

2. The secondary battery according to claim 1, wherein
the electrode assembly includes a plurality of the positive electrodes and a plurality of the negative electrodes, each of which has a substantially rectangular shape in front view, and
the tape is attached to a position overlapping with a center in a long side direction of each of the positive electrodes and the negative electrodes.

3. The secondary battery according to claim 1, wherein
the electrode assembly includes a plurality of the positive electrodes and a plurality of the negative electrodes, and has a stacking structure in which one sheet of the separator folded in a zigzag shape is interposed between the positive electrodes and the negative electrodes, and the tubular portion is formed by the one sheet of separator.

4. The secondary battery according to claim 1, wherein
the first layer is a resin layer, and
the second layer is a heat resistant layer containing inorganic particles.

5. The secondary battery according to claim 4, wherein
the separator is provided so that the heat resistant layer faces the positive electrode side.

6. The secondary battery according to claim 4, wherein
the separator is provided so that in the tubular portion, the resin layer faces an inner side, and the heat resistant layer faces an outer side.

7. The secondary battery according to claim 1, wherein
an adhesive layer to be bonded to the positive electrode or the negative electrode is formed on at least one surface of the separator.
